(19) United States
(12) Patent Application Publication
(10) Pub. No.: US 2024/0349700 A1
(43) Pub. Date: Oct. 24, 2024

(54) JOGGING BELT AND LEASH SYSTEM WITH ADJUSTABLE QUICK RELEASE AND CUSTOMIZABLE LEASH AND COLLAR COMBINATION

(71) Applicant: Sporn Pet Products, Inc., New York, NY (US)

(72) Inventor: Joseph SPORN, New York, NY (US)

(21) Appl. No.: 18/638,433

(22) Filed: Apr. 17, 2024

Related U.S. Application Data
(60) Provisional application No. 63/460,222, filed on Apr. 18, 2023.

(51) Int. Cl. A01K 27/00

(52) U.S. Cl. CPC A01K 27/005; A01K 27/003

(57) ABSTRACT

A leash may include a first snap that is connected to a first end of the leash, a first handle connected to the first snap, a first D-ring connected to the first handle, a first bungee web connected to the first handle, a second handle connected to the first bungee web, a second bungee web connected to the second handle, a collar section connected to the second bungee web, a second snap connected to the collar section, a glide slidably attached to the collar section, and a second D-ring attached to the glide. A hands-free belt may be worn by a person and the first snap may be attached to a slidable O-ring on the hands-free belt. Alternatively, the first snap may be attached to the first D-ring to create a handle. The second snap may be connected to the second D-ring to create a collar from the collar section.

### CROSS-REFERENCE TO RELATED APPLICATIONS

This U.S. Non-Provisional patent application claims the benefit of U.S. Provisional Application No. 63/460,222, filed Apr. 18, 2023 and titled Jogging Belt and Leash System with Adjustable Quick Release and Customizable Leash and Collar Combination, which is fully incorporated herein by reference as if fully set forth herein.

### FIELD OF THE INVENTION

The present invention relates to an apparatus to be used while walking an animal and more particularly to a leash that allows a person to safely move while walking or running with a dog.

### BACKGROUND

Apparatus specifically designed to control and walk a dog are known. For example, a dog harness is a piece of equipment comprising one or more straps that surround the dog's torso. The harness may be used to control the movements of a dog in a safe and humane manner. The harness may reduce undesirable tension on the neck of the dog while maintaining freedom of movement for the dog. The harness may also be designed to efficiently utilize a dog's pulling power, without hurting the dog.

A leash, sometimes referred to as a lead, lead line or tether, may be attached to the harness and used by a human to guide and control the dog. The leash may be made of one or more different materials, such as rope, leather or chain. The length of the leash controls the maximum distance the dog can be from the human holding the leash. The human may control the movements of the dog through movements of the leash (and possibly voice commands). With practice and training (of both the human and the dog), the human may exercise a great deal of control over the movements of the dog with small and controlled movements from the leash.

### SUMMARY OF THE INVENTION

Accordingly, the invention is directed to a leash that allows a person to safely walk or run while walking (or running) a dog.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The present invention provides a hands-free belt, i.e., a jogging belt, and leash system for dogs and their owners that features a wide (at least two inches) hands-free belt width an adjustable quick release for the hands-free belt. The leash, that may be attached to the hands-free belt, is designed to function as an independent leash that may be used with the dog's other harnesses and collars or adjusted to function as an adjustable leash and collar combination. The system provides comfort, safety, and convenience during outdoor activities and sets it apart from all other similar jogging systems for dogs and their owners.

In an example embodiment, a leash may have a first snap. The first snap may be connected to a hands-free belt worn by a person walking or running the dog so that the person does not have to hold the leash with their hands while running. Alternatively, the first snap may be attached to a first D-ring on the leash to thereby form a first handle created from a portion of the leash between the first snap and the first D-ring.

After the first handle, the leash may have a first bungee web section which may be clastic and may provide some shock absorption when the person and/or dog create tension on the leash.

After the first bungee web section, the leash may have a second handle that provides another location for the person to grab onto the leash. The second handle allows the person to effectively shorten the leash as the second handle will be closer to the dog than the first handle.

After the second handle, the leash may have a second bungee web section, which may also be elastic and may provide some shock absorption when the person and/or dog create tension on the leash. The location of the second bungee web section after the second handle means the person will be able to use the shock absorption of the second bungee web section, even when the person is using the second handle.

After the second bungee web section, the leash may have a collar portion of the leash. A glide may be slidably attached to the collar portion of the leash. A second D-ring may be attached to the glide (which is slidably attached to the collar portion of the leash). An adjustably sized collar may be formed by attaching a second snap to the second D-ring attached to the slidable glide. A third handle may be attached to a portion of an outer surface of the collar portion of the leash.

Alternatively, the person may attach the second snap to a collar or harness already worn by the dog. This would cause the collar portion of the leash to merely act as an additional length of the leash but would still allow the third handle to be used when desired.

This Summary section is neither intended to be, nor should be, construed as being representative of the full extent and scope of the present disclosure. Additional benefits, features and embodiments of the present disclosure are set forth in the attached figures and in the description hereinbelow, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an upper perspective view of an animal leash apparatus arranged in accordance with the present invention;

FIG. 2 is a right side elevation view of the animal leash;

FIG. 3 is a left side elevation view of the animal leash;

FIG. 4 is a rear elevation view of the animal leash;

FIG. 5 is a front elevation view of the animal leash;

FIG. 6 is a top plan view of the animal leash;

FIG. 7 is a bottom plan view of the animal leash;

FIG. 8 is a top plan view of the animal leash; and

FIG. 9 illustrates a hands-free belt that may be used in combination with the animal leash.

### DETAILED DESCRIPTION OF THE ILLUSTRATED EMBODIMENTS

The following detailed description describes a leash apparatus that allows a person to move while walking or running with a dog. An apparatus and method are presented to enable any person skilled in the art to make and use the disclosed subject matter in the context of one or more particular implementations. Various modifications, alterations, and permutations of the disclosed implementations can be made and will be readily apparent to those skilled in the art, and the general principles defined may be applied to other implementations and applications, without departing from scope of the disclosure. The present disclosure is not intended to be limited to the described or illustrated implementations, but to be accorded the widest scope consistent with the described principles and features.

For the purpose of promoting an understanding of the principles of the present disclosure, reference will now be made to the exemplary embodiments illustrated in the drawing(s), and specific language will be used to describe the same.

Appearances of the phrases an “embodiment,” an “example,” or similar language in this specification may, but do not necessarily, refer to the same embodiment, to different embodiments, or to one or more of the figures. The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps unless explicitly stated otherwise.

In order to more fully appreciate the present disclosure and to provide additional related features, each of the following references are fully incorporated herein by reference in their entirety:

(1) U.S. Pat. No. 7,497,186 discloses an animal self-carried hydrating system comprises an animal harness, a fluid container for holding the fluid, and a fluid dispensing mechanism. The animal harness is securable on the animal by a fastening system. The animal harness has a fluid pocket for holding the fluid container. The fluid dispensing mechanism is attached to the fluid container, in fluid communication with the fluid in the fluid container. The fluid dispensing mechanism is such that it can dispense fluid from the fluid container to the animal while the fluid container is in the fluid pocket.

(2) U.S. Pat. No. 9,241,474 teaches an animal harness for an animal that includes a loop of webbing, which encircles the back, neck and shoulder of the animal. A pouch is affixed to the loop. A pulsating device is disposed within the pouch and transmits same to the animal through the chest and about its heart to calm the animal during transport.

(3) U.S. Pat. No. 6,568,575 discloses a harness with detachable and interchangeable pouches comprises two torso straps extending downwardly and outwardly from a central coupler assembly, two shoulder straps, and two belly straps. The harness is adjustable to fit nearly any body size. The pouches are attached to the harness with quick-releasing retaining clips and to each other by the belly straps. Each pouch includes front and rear panels that are formed using either a right-side template or a left-side template and is interchangeable with any other pouch designed using the same template. The interchangeability allows the wearer to install pouches that are best suited for a particular activity. Each pouch is designed such that, when worn, it hangs at an angle which causes its top to slant downwardly toward the middle of the wearer's torso, thereby increasing the accessibility of the pouch contents.

(4) U.S. Pub. No. 2017/0215385 relates to a novel pet harness and pack for comfortably harnessing a dog and providing a dispenser for waste bags one on side of the harness and a storage pouch on the opposite side. The pouches are colorfully decorated with character faces and the bags will dispense out of a portion of the character's face. A metal loop is provided beneath a cross-stitched reinforced section of fabric wherein a leash may be attached to the harness.

(5) U.S. Pat. No. 11,357,694 teaches a retractable leash assembly for a pet animal, such as a dog. The leash assembly includes a casing body with a handle attached to the body by an at least one hinge joint, a braking device, and a spool arrangement with an extendable lead line wound thereabout and configured attachable to the pet animals' collar or harness, wherein in the leash assembly the handle is configured to articulate about the joint with regard to the casing body, the articulation movement of the handle being triggered by the pulling force exerted on the lead line by the animal kept on the leash, and wherein, by virtue of the articulation movement the braking device actuates a braking action causing the lead line to reduce unwinding speed proportionally with an increase in the pulling force.

(6) U.S. publication No. 2022/0167592 relates to a leash extender with a larger round wrist loop and a smaller round handle loop connected by an extension. A user will wrap the leash extender around the handle of a pet leash and pass the wrist loop through the handle loop and pull securely. The leash extender is made of a soft, flexible material and has no edges, so is very comfortable around the user's wrist.

(7) U.S. Pub. No. 2022/0125016 teaches a dog leash that includes a dog leash body. An end of the dog leash body is provided with an annulus structure and forms a traction part. The traction part is provided with a buckle by butt-and-collar joint. The root segment of the traction part is covered with a sheath. The dog leash adapts flexible steel wire rope with good flexibility and high strength. The steel wire rope is coated with plastic layer, which has good touch feeling and high use comfort.

Reference will now be made in detail to an embodiment of the present invention, examples of which are illustrated in the accompanying drawings.

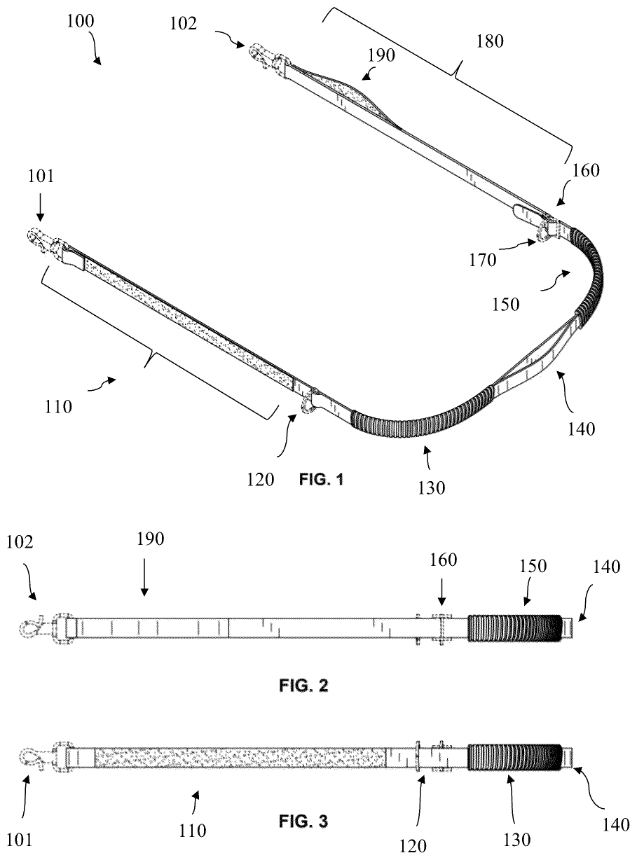

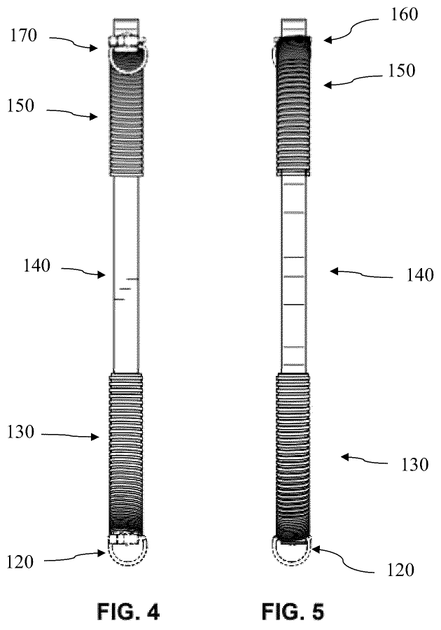

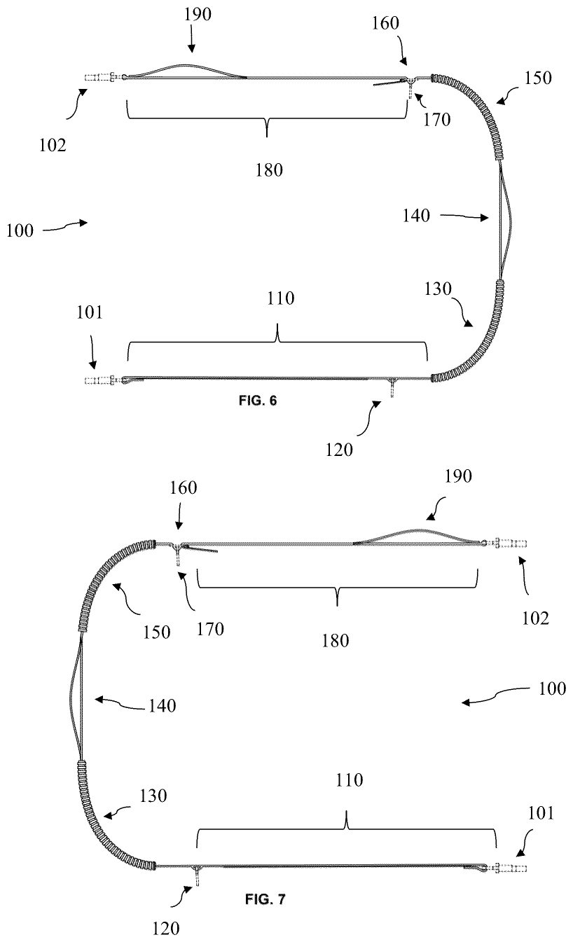

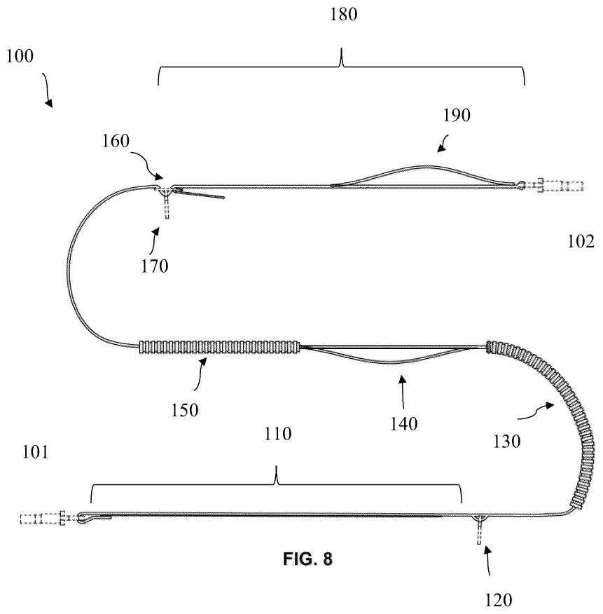

The present invention will now be discussed with reference to FIGS. 1-9, which illustrate various views of a leash 100. While the various embodiments will generally describe the animal being walked as a dog, it should be understood that the leash 100 may be used to walk other types of animals as well. While the leash 100 has features useful for a person and dog to run together, it should also be understood that the leash may also be used by a person and dog walking together.

Jogging with dogs requires a secure and comfortable system that preferably allows the owner to run hands-free (not holding the leash 100 in the person's hands) while providing control and safety for the dog. Additionally, the system may be customizable to fit various sizes and shapes of dogs. The prior art has not adequately addressed the need for a customizable leash and collar combination that can be used with a wide (at least two inches) hands-free belt 900 width and an adjustable quick release for the hands-free belt 900. The hands-free belt 900 having a belt that is at least two inches wide distributes the force of a resistant dog over a larger surface area of the hands-free belt 900, thereby providing added safety and comfort to the person using the hands-free belt 900.

The leash 100 may include a first snap 101 on a first end of the leash 100 and a second snap 102 on a second end of the leash 100. The first snap 101 and the second snap 102 may be any desired type of attachment device configured to attach the leash 100 to an animal, a person, a D-ring and/or other predetermined locations or apparatus. As non-limiting examples, the first snap 101 and/or the second snap 102 may be any combination of snap hooks, clamps, clasps, buckle collars and/or clips.

The first snap 101 and the second snap 102 may be made of any durable material that can withstand a dog pulling on the leash 100. As non-limiting examples, the first snap 101 and the second snap 102 may be made of a durable plastic, resin, composite material, metal or any combinations of the same and the like.

In one embodiment, the first snap 101 is configured to be able to be attach to either an O-ring 910 on a hands-free belt 900 or a first D-ring 120. When the first snap 101 is attached to the O-ring 910 on the hands-free belt 900, a person running with a dog does not need to use their hands to hold the leash 100 as the leash 100 is attached to the hands-free belt 900 at the O-ring 910. When the first snap 101 is attached to the first D-ring 120, a first handle 110 is created from the material between the first snap 101 and the first D-ring 120. A person may use the first handle 110 to control the leash 100 and the dog.

The material between the first snap 101 and the first D-ring 120 may be made of any desired material. As non-limiting examples, the material may be felt, a flat webbing, rope, leather, nylon, chain, cloth, any other desired material or some combination thereof. In a preferred embodiment, the first handle 110 is made of a webbing with an inner surface lined with felt to provide a comfortable surface that comes into contact with the person's hand when the first handle 110 is created and used. The material between the first snap 101 and the first D-ring 120 may be any desired length (distance between the first snap 101 and the first D-ring) but is preferably longer than 10 inches and shorter than 30 inches but is most preferably about 19 inches.

The leash 100 may include a first bungee web 130 section of the leash 100 after the first handle 110. The first bungee web 130 may be any desired length and may include any durable material. As non-limiting examples the first bungee web 130 may be longer than two inches, but shorter than 20 inches, but is most preferably about 6 inches long. The first bungee web 130 may be made of any desired material, but the material is preferably elastic. Material that is elastic is hereby defined to be able to be stretched by at least 10% without causing visual damage to the material. As non-limiting examples, the first bungee web 130 may be made of rubber or a bungee cord covered in a nylon or cotton sheath.

The leash 100 may include a second handle 140 on the leash 100 after the first bungee web 130 section. The second handle 140 may be used by a person to hold onto the leash 100. The second handle 140 may comprise a portion of the leash 100 having a bottom layer and a top layer that may be separated to form the second handle 140. The bottom layer and the top layer of the second handle 140 may be made of any desired material. As non-limiting examples, the material may be felt, webbing, rope, leather, nylon, chain, cloth, any other desired material or some combination thereof. In a preferred embodiment, the bottom layer and the top layer of the second handle 140 is made of a webbing with an inner surface lined with felt to provide a comfortable surface that comes into contact with the person's hand. The second handle 140 may be any desired length but is preferably longer than 5 inches and shorter than 20 inches but is most preferably about 7.5 inches.

The leash 100 may include a second bungee web 150 after the second handle 140 on the leash 100. The second bungee web 150 may be any desired length. As non-limiting examples, the second bungee web 150 may be longer than two inches, but shorter than 20 inches, but is most preferably about 7 inches long. The second bungee web 150 may be made of any desired material, but the material is preferably elastic. As non-limiting examples, the second bungee web 150 may be made of rubber or a bungee cord covered in a nylon or cotton sheath.

A glide 160 may be movably or slidably attached to a collar section 180 of the leash 100. A second D-ring 170 may be attached to the glide 160. The second snap 102 may be connected and attached to the second D-ring 170 so that the material between the second snap 102 and the second D-ring 170 (the collar section 180) forms a collar that fits around the dog's neck. The glide 160 may be moveable/slidable along the collar section 180 of the leash 100 such that the position of the glide 160 (and thus the second D-ring 170 attached to the glide 160) on the collar section 180 determines the size of the created collar. The created collar may be any desired size. As a non-limiting example, the collar section 180 may be longer than 10 inches and shorter than 30 inches. In a preferred embodiment, the collar section 180 of the leash 100 is about 22 inches long, but the movable second D-ring 170 allows the portion of the collar section 180 that fits around the neck of the dog to be adjusted so that the portion of the collar section 180 that fits around the dog's neck may be between 12 inches and 22 inches.

In another embodiment, the second snap 102 on the leash 100 may be configured to be attached to a harness, collar or similar item worn by the dog (separate from the leash 100) to control and guide the movements of the dog.

The collar section 180 of the leash 100 may be made of any desired material. As non-limiting examples, the material may be felt, webbing, rope, leather, nylon, chain, cloth, any other desired material or some combination thereof.

A portion of the collar section 180 may comprise a third handle 190. The third handle 190 may be any desired length but is preferably shorter than the collar section 180, longer than 5 inches, shorter than 20 inches but most preferably the third handle 190 is 7.5 inches. In a preferred embodiment, the third handle 190 is made of a webbing with an inner surface lined with felt to provide a comfortable surface that comes into contact with the person's hand when the person is grasping the third handle 190.

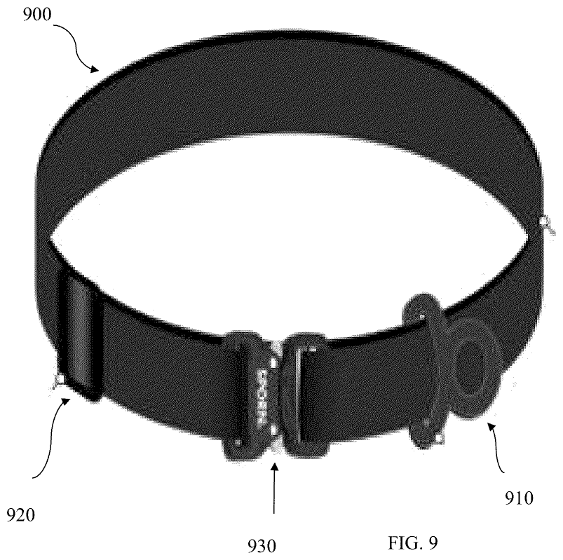

Referring to FIG. 9, the person walking or running the dog may wear a hands-free belt 900. The effective length of the hands-free belt 900 may be adjusted using a slide 920 that shortens or lengthens the effective length of the hands-free belt 900 as the slide 920 slides along the length of the hands-free belt 900. The hands-free belt 900 may have any type of buckle, but preferably has a quick release buckle 930 for keeping the hands-free belt 900 on the person. The hands-free belt 900 may be made of any desired material but is preferably made of an at least two-inch wide seatbelt webbing. The hands-free belt 900 may also include an O-ring 910 that can slide along the hands-free belt webbing. The first snap 101 on the leash 100 may be attached to the O-ring 910 on the hands-free belt 900 so that the person does not have to use their hands to control the leash 100.

In a preferred embodiment, the leash 100 comprises, in sequential order from the first end of the leash 100 to the second end of the leash 100, the first snap 101, the first handle 110, the first bungee web 130, the second handle 140, the second bungee web 150, the collar section 180 and the second snap 102.

The inventions and methods described herein can be viewed as a whole, or as a number of separate inventions, that can be used independently or mixed and matched as desired. All inventions, steps, processes, devices, and methods described herein can be mixed and matched as desired. All previously described features, functions, or inventions described herein or by reference may be mixed and matched as desired.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A leash for allowing a person to walk or run with a dog, comprising:
a first snap attached to a first end of the leash;
a first handle connected to the first snap;
a first D-ring connected to the first handle;
a first bungee web connected to the first handle;
a second handle connected to the first bungee web;
a second bungee web connected to the second handle;
a collar section connected to the second bungee web;
a second snap connected to the collar section;
a glide slidably attached to the collar section; and
a second D-ring attached to the glide.

2. The leash of claim 1, wherein the first snap, the first handle and the first D-ring are configured to form a handle when the first snap is connected to the first D-ring.

3. The leash of claim 1, wherein the first bungee web comprises an elastic material.

4. The leash of claim 3, wherein the second bungee web comprises an elastic material.

5. The leash of claim 1, wherein at least a portion of the collar section comprises a third handle.

6. The leash of claim 1, wherein the second snap, the collar section and the second D-ring are configured to form a collar when the second snap is connected to the second D-ring.

7. The leash of claim 1, wherein the leash comprises, in sequential order from a first end of the leash to a second end of the leash, the first snap, the first handle, the first bungee web, the second handle, the second bungee web, the collar section and the second snap.

8. The leash of claim 1, wherein the first snap is configured to not be connected to anything at a first time, thereby creating a longer leash, the first snap is configured to be connected to an O-ring on a hands-free belt at a second time, thereby creating a hands-free dog walking experience for the person walking the dog and the first snap is configured to be connected to the first D-ring at a third time, thereby creating a handle using material from the first handle between the first snap and the first D-ring.

9. The leash of claim 8, wherein the second snap is configured to be connected to a first collar of the dog at a first time and the second snap, the collar section and the second D-ring are configured to form a second collar when the second snap is connected to the second D-ring at a second time.

10. A leash and a hands-free belt for allowing a person to walk or run with a dog, comprising:
a hands-free belt, comprising a belt and an O-ring;
a first snap configured to be attached to the O-ring of the hands-free belt;
a first handle connected to the first snap;
a first D-ring connected to the first handle;
a first bungee web connected to the first handle;
a second handle connected to the first bungee web;
a second bungee web connected to the second handle;
a collar section connected to the second bungee web;
a second snap connected to the collar section;
a glide slidably attached to the collar section; and
a second D-ring attached to the glide.

11. The leash of claim 10, wherein the O-ring is configured to slide along a length of the belt.

12. The leash of claim 10, wherein the hands-free belt comprises a quick release buckle.

13. The leash of claim 10, wherein the belt of the hands-free belt is at least two inches wide.

14. The leash of claim 10, wherein the first bungee web comprises an elastic material.

15. The leash of claim 10, wherein the second bungee web comprises an elastic material.

16. The leash of claim 10, wherein at least a portion of the collar section comprises a third handle.

17. The leash of claim 10, wherein the second snap, the collar section and the second D-ring are configured to form a collar when the second snap is connected to the second D-ring.

18. The leash of claim 10, wherein the leash comprises, in sequential order from a first end of the leash to a second end of the leash, the first snap, the first handle, the first bungee web, the second handle, the second bungee web, the collar section and the second snap.

19. The leash of claim 10, wherein the first snap is configured not be connected to anything at a first time, thereby creating a longer leash, the first snap is configured to be connected to an O-ring on a hands-free belt at a second time, thereby creating a hands-free dog walking experience for the person walking the dog and the first snap is configured to be connected to the first D-ring at a third time, thereby creating a handle using material from the first handle between the first snap and the first D-ring.

20. The leash of claim 10, wherein the second snap is configured to be connected to a first collar of the dog at a first time and the second snap, the collar section and the second D-ring are configured to form a second collar when the second snap is connected to the second D-ring at a second time.

21.-31. (canceled)
